(19) United States
(12) Patent Application Publication
(10) Pub. No.: US 2021/0051241 A1
(43) Pub. Date: Feb. 18, 2021

(54) SCANNER CAPABLE OF COMPENSATING FOR DISTORTION

(71) Applicant: Hewlett-Packard Development Company, L.P., Spring, TX (US)

(72) Inventor: Kyoungrok KIM, Seongnam-si (KR)

(21) Appl. No.: 16/977,167

(22) PCT Filed: Mar. 21, 2019
(86) PCT No.: PCT/US2019/023399

§ 371 Date: Sep. 1, 2020

(30) Foreign Application Priority Data
Mar. 29, 2018 (KR) 10-2018-0036910

(51) Int. Cl. H04N 1/00; H04N 1/047; H04N 1/12; H04N 1/193

(52) U.S. Cl. CPC H04N 1/00872; H04N 1/1936; H04N 1/1215; H04N 1/047

(57) ABSTRACT

A scanner includes an image read unit including a linear image sensor having a length in a main scanning direction, a compensation value calculation unit to compare data read from a main scanning reference pattern including a plurality of main scanning sections arranged in the main scanning direction with data of the main scanning reference pattern that is previously stored, and to calculate a plurality of main scanning scale compensation values respectively corresponding to the plurality of main scanning sections, and an image processing unit to compensate for distortion in the main scanning direction by dividing an image read from the document into a plurality of main scanning image areas respectively corresponding to the plurality of main scanning sections and applying the plurality of main scanning scale compensation values respectively to the plurality of main scanning image areas.

### BACKGROUND

Scanners may obtain image data by irradiating light onto a document, imaging light reflected from the document onto an image sensor using imaging optics, and performing photoelectric transformation on a formed optical image to generate an electrical signal. An image sensor is a one-dimensional linear sensor having a length in a main scanning direction. While moving a scan module in a sub-scanning direction, a one-dimensional image is continuously read out by using the image sensor and a two-dimensional image may be formed through image processing performed on read-out image data.

### BRIEF DESCRIPTION OF DRAWINGS

The above and other aspects, features, and advantages of certain examples of the present disclosure will be more apparent from the following description taken in conjunction with the accompanying drawings, in which:

FIGS. 1 and 2 schematically illustrate configurations of a scanner, according to various examples;

FIG. 3 is a schematic block diagram of a scanner, according to an example;

FIG. 4 illustrates a main scanning reference pattern, according to an example;

FIG. 5 illustrates a main scanning reference pattern, according to an example;

FIG. 6 illustrates a main scanning reference pattern, according to an example;

FIG. 7 is a perspective view of a scanner, according to an example;

FIG. 8 illustrates a main scanning distortion compensation process, according to an example;

FIG. 9 illustrates a sub-scanning reference pattern and a sub-scanning distortion compensation process, according to various examples; and

FIG. 10 illustrates a compensation chart, according to an example.

Throughout the drawings, it should be noted that like reference numbers are used to depict the same or similar elements, features, parts, components, and structures and thus, a repeated description thereof may be omitted.

### DETAILED DESCRIPTION OF EXAMPLES

Reference will now be made to examples, which are illustrated in the accompanying drawings. In this regard, the examples may have different forms and should not be construed as being limited to the descriptions set forth herein. In order to further clearly describe features of the examples, descriptions of other features that are well known to one of ordinary skill in the art are omitted herein.

In the specification, when an element is “connected” to another element, the elements may not only be “directly connected,” but may also be “electrically connected” via another element therebetween. Also, when a region “includes” an element, the region may further include another element instead of excluding the other element, unless otherwise differently stated.

Expressions such as “at least one of,” when preceding a list of elements, modify the entire list of elements and do not modify the individual elements of the list.

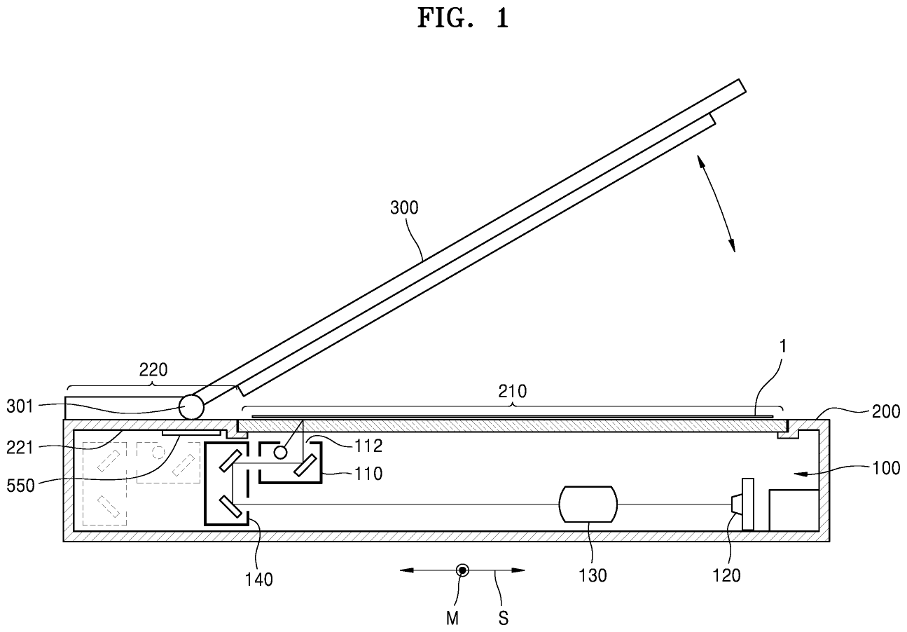

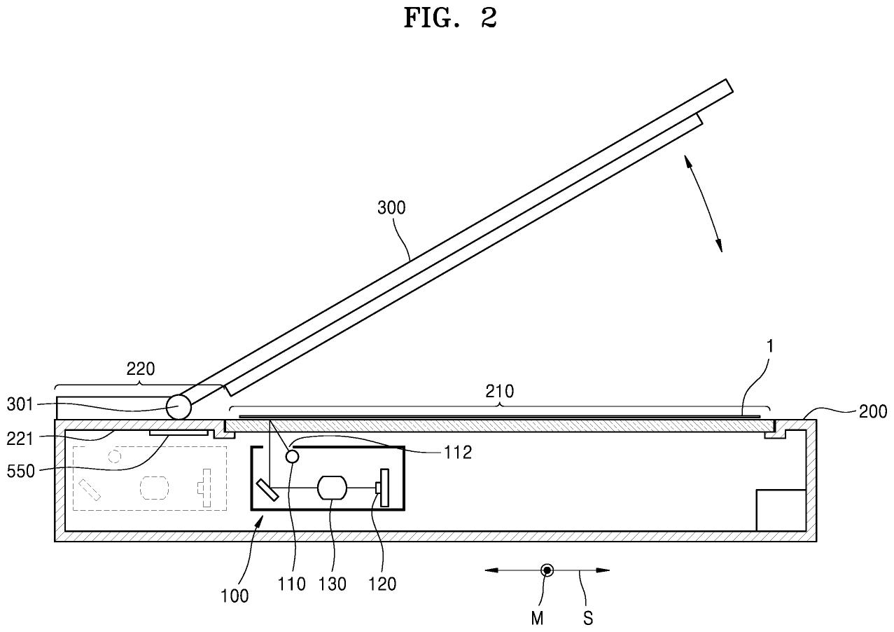

FIGS. 1 and 2 schematically illustrate configurations of a scanner, according to various examples.

Referring to FIG. 1, a scanner may include an image read unit 100 and a platen cover 200 located above the image read unit 100.

The image read unit 100 emits light onto an object, for example, a document 1 placed on the platen cover 200, to read image information of the object, receives light reflected from the document 1, and performs photoelectric transformation. The image read unit 100 may include an illumination unit 110 that emits light onto the document 1, a linear image sensor 120 having a length in a main scanning direction M, and imaging optics 130 that image the light reflected from the document 1 on the linear image sensor 120.

The illumination unit 110 may emit a monochromatic light onto the document 1. The illumination unit 110 may emit a white light onto the document 1 for color scanning. In this case, the linear image sensor 120 may be provided with a color filter for color separation of the white color into lights of red (R), green (G), and blue (B) colors, and R, G, and B pixels for respectively receiving the color-separated R, G, and B lights. Alternatively, the illumination unit 110 may sequentially emit the R, G, and B lights onto the document 1 for color scanning.

The light emitted from the illumination unit 110 onto the document 1 is incident on the linear image sensor 120 via the imaging optics 130. The linear image sensor 120 transforms an optical signal to an electrical signal through photoelectric transformation. The linear image sensor 120 may include, for example, a charge coupled device (CCD).

As described above, the linear image sensor 120 is a one-dimensional sensor having a length in the main scanning direction M. To obtain two-dimensional image data, at least one of the illumination unit 110, the imaging optics 130, and the linear image sensor 120 may be moved in a sub-scanning direction S. In an example of the scanner illustrated in FIG. 1, the linear image sensor 120 and the imaging optics 130 are located at fixed positions, whereas the illumination unit 110 is moved in the sub-scanning direction S. In this state, since the length of an optical path from the document 1 to the imaging optics 130 needs to be constant regardless of the position of the illumination unit 110 in the sub-scanning direction S, a reflection member 140 for guiding the light reflected from the document 1 toward the imaging optics 130 may be moved in the sub-scanning direction S at a speed equivalent to half of the moving speed of the illumination unit 110.

The structure of the image read unit 100 is not limited to the example illustrated in FIG. 1.

Referring to FIG. 2, the image read unit 100 including the illumination unit 110, the imaging optics 130, and the linear image sensor 120 may entirely move in the sub-scanning direction S.

The scanner may include the platen cover 200 provided above the image read unit 100. The platen cover 200 may include a transmissive read area 210 on which the document 1 is placed, and a home position area 220. The transmissive read area 210 may be formed of, for example, a transmissive material such as glass capable of transmitting light. The home position area 220 is located at a side of the transmissive read area 210 in the sub-scanning direction S. The image read unit 100, when not performing a scan operation, may be located in the home position area 220. When the image read unit 100 is located in the home position area 220, a transmissive window 112, through which at least illumination light and the light reflected from the document 1 pass, is located in the home position area 220, out of the transmissive read area 210. In the example of FIG. 1, when no scan operation is performed, the illumination unit 110 and the reflection member 140 are moved such that the transmissive window 112 is located in the home position area 220. In the example of FIG. 2, the image read unit 100, when not performing the scan operation, is entirely moved such that the transmissive window 112 is located in the home position area 220.

The scanner may include an upper cover 300 that may be opened and closed and covers the platen cover 200. Being capable of opening and closing may mean that the upper cover 300 is movable to a position (first position) for exposing an upper portion of the platen cover 200 to allow the document 1 to be placed on the platen cover 200 and a position (second position) for covering the platen cover 200. In the present example, the upper cover 300 pivots around a hinge 301 and may move from one of the first position and the second position to the other of the first position and the second position, or positions in between.

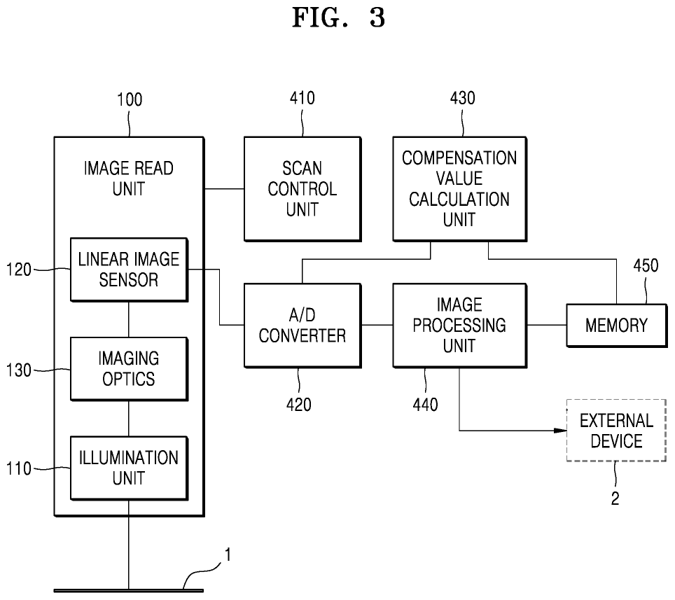

FIG. 3 is a schematic block diagram of a scanner, according to an example.

Referring to FIG. 3, a scan control unit 410 controls a scan operation of the image read unit 100. When a scan start signal is input from a host (not shown) or an operation panel (not shown) of the scanner, the scan control unit 410 controls a driving unit (not shown) to move the image read unit 100 in the sub-scanning direction S and controls the image read unit 100 to perform a scan operation.

The optical signal reflected from the document 1 and imaged by the imaging optics 130 on the linear image sensor 120 is photoelectrically transformed to an electrical signal by the linear image sensor 120. The electrical signal is converted by an A/D converter 420 to a digital value. An image processing unit 440 may create image data from the digital value, and store the image data in a storage unit, for example, a memory 450, or output the image data to an external device 2, for example, a printer or a host device.

The length of the linear image sensor 120 in the main scanning direction M may be shorter than a length of the document 1 in the main scanning direction M. Accordingly, the imaging optics 130 may be a reduction imaging optics that images the document 1 on the linear image sensor 120 by reducing the image in the main scanning direction M. The imaging optics 130 may include one or more lenses.

In a scanner adopting the reduction imaging optics, distortion in the main scanning direction M may be generated due to a factor such as distortion of a lens or positional errors of parts affecting the length of the optical path from the document 1 to the linear image sensor 120. To compensate for the distortion, a scale compensation chart (not shown) is read, and a scale compensation value is obtained by measuring a distance between two corners close to the outermost side of the scale compensation chart in the main scanning direction M from the read data. The distortion may be compensated by using the scale compensation value.

The distortion due to the positional errors of parts affecting the length of the optical path from the document 1 to the linear image sensor 120 may be compensated by the above compensation method. However, the distortion of a lens may vary according to a distance from an optical axis of a lens in the main scanning direction M. In other words, the distortion of a lens may be irregular or non-linear in the main scanning direction M. The irregularity of the lens distortion in the main scanning direction M may be caused by a manufacturing error or spherical error of a lens. According to the above-described compensation method, although distortion with respect to the overall length of the read image data in the main scanning direction M is compensated to a degree, the distortion due to the irregularity of the lens distortion in the main scanning direction M may not be compensated.

To compensate for the lens distortion that is irregular in the main scanning direction M, the scanner according to the present example reads a reference pattern and calculates a scale compensation value from the reference pattern in a plurality of areas in the main scanning direction M. The scanner may compensate for the image data read from the document 1 by applying the scale compensation value thereto.

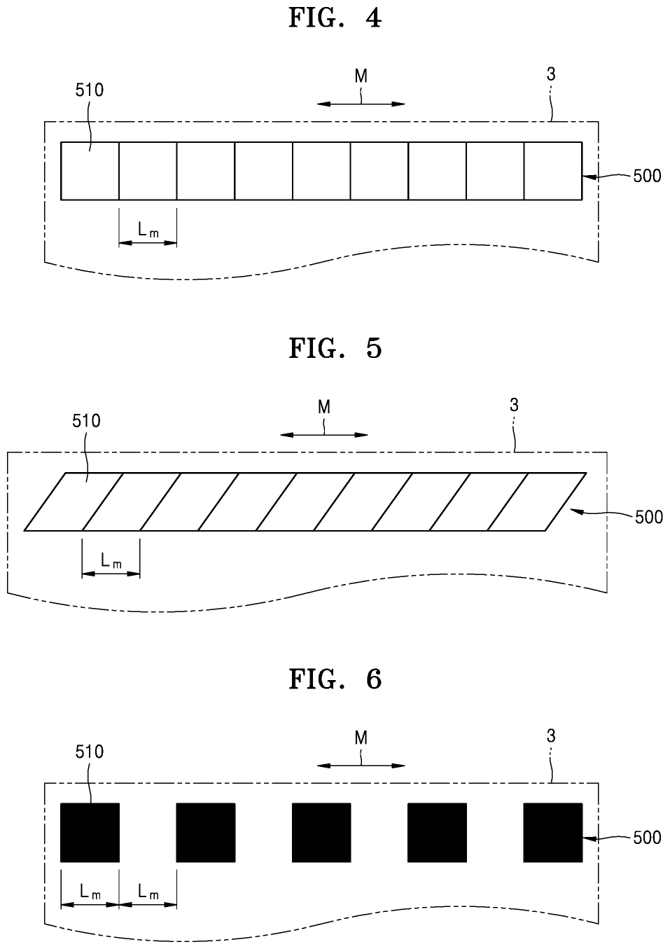

FIG. 4 illustrates a main scanning reference pattern, according to an example.

Referring to FIG. 4, a main scanning reference pattern 500 may include a plurality of main scanning sections 510 and may be provided in the form of a compensation chart 3. The main scanning sections 510 are arranged in the main scanning direction M. The length Lₘ of each of the main scanning sections 510 may be the same or different from each other. In the present example, the length Lₘ of each of the main scanning sections 510 is the same. The number of the main scanning sections 510 is not particularly limited, and as the number thereof increases, the compensation of main scanning distortion may be performed more accurately. For example, with respect to an A3 sized image, the main scanning reference pattern 500 may include fifteen main scanning sections 510 each having a length of about 20 mm. Information about the main scanning reference pattern 500, for example, the number and length Lₘ of the main scanning sections 510 may be previously stored in the memory 450.

To compensate for the lens distortion that is irregular in the main scanning direction M, the scanner according to an example may include a compensation value calculation unit 430 for calculating a plurality of main scanning scale compensation values respectively corresponding to the main scanning sections 510. The compensation value calculation unit 430 may calculate the plurality of main scanning scale compensation values by comparing data read from the main scanning reference pattern 500, including the main scanning sections 510 arranged in the main scanning direction M, with previously stored data of the main scanning reference pattern 500. The image processing unit 440 divides the image read from the document 1 into a plurality of main scanning image areas respectively corresponding to the main scanning sections 510, and respectively applies the main scanning scale compensation values to the main scanning image areas, thereby compensating for the distortion in the main scanning direction M.

The main scanning reference pattern 500 may be implemented in various forms. For example, the main scanning reference pattern 500 may include a plurality of linear patterns arranged spaced apart from each other in the main scanning direction M. Each of the main scanning sections 510 is defined by two neighboring linear patterns of the plurality of linear patterns. The linear patterns may have a shape extending in the sub-scanning direction S. The main scanning reference pattern 500 having a shape of a plurality of lattice patterns illustrated in FIG. 4 is an example of the main scanning reference pattern 500 including a plurality of linear patterns extending in the sub-scanning direction S.

FIG. 5 illustrates a main scanning reference pattern, according to an example.

Referring to FIG. 5, the main scanning reference pattern 500 may include a plurality of linear patterns arranged spaced apart from each other in the main scanning direction M and obliquely inclined with respect to the main scanning direction M. Each of the main scanning sections 510 is defined by two neighboring linear patterns of the plurality of linear patterns.

FIG. 6 illustrates a main scanning reference pattern, according to an example.

Referring to FIG. 6, the main scanning reference pattern 500 may include a plurality of solid patterns arranged spaced apart from each other in the main scanning direction M. Each of the main scanning sections 510 may be defined by each of the solid patterns and two neighboring solid patterns.

In this case, to obtain a scale compensation value, the scanner reads the compensation chart 3 placed in the transmissive read area 210 of the platen cover 200.

In an example, the main scanning reference pattern 500 may be integrally formed in the scanner. With such a configuration, there is no need to prepare a separate compensation chart for distortion compensation.

The main scanning reference pattern 500 may be located in the home position area 220 of the platen cover 200. As an example, referring to FIGS. 1 and 2, the main scanning reference pattern 500 may be formed on a lower portion 221 of the home position area 220 of the platen cover 200 to be read by the image read unit 100. As an example, the main scanning reference pattern 500 may be printed on a sheet member 550 and coupled to the lower portion 221 of the home position area 220 of the platen cover 200 to be read by the image read unit 100. As an example, the sheet member 550 may be a shading sheet that is a reference of shading compensation, and the main scanning reference pattern 500 may be formed on a shading sheet. When the image read unit 100 is located in the home position area 220 or moves from the home position area 220 to the transmissive read area 210, the scan control unit 410 may control the image read unit 100 to read the main scanning reference pattern 500.

As another example, the main scanning reference pattern 500 may be located on the upper cover 300 to be read by the image read unit 100.

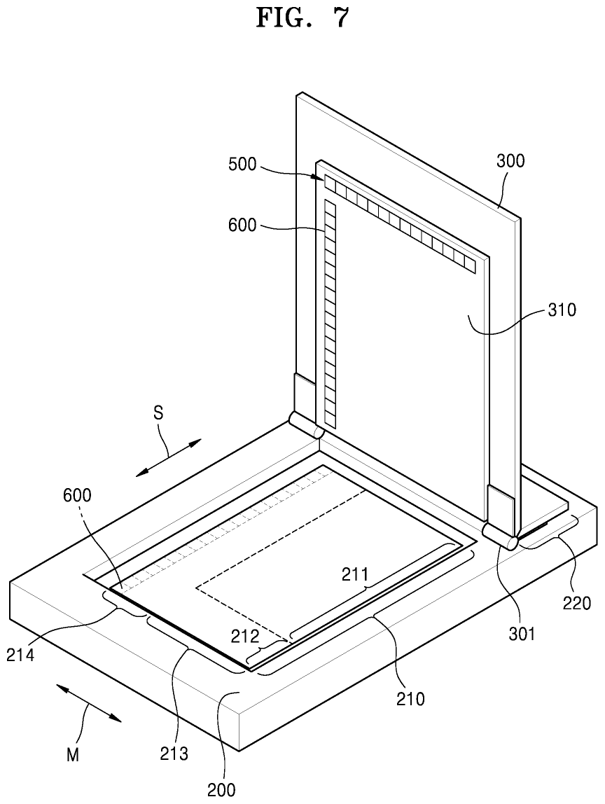

FIG. 7 is a perspective view of a scanner, according to an example.

Referring to FIG. 7, a white sheet 310 is provided on an inner side of the upper cover 300 corresponding to the platen cover 200, and the main scanning reference pattern 500 may be formed on the white sheet 310. In this case, the main scanning reference pattern 500 may be formed on the white sheet 310 such that the main scanning reference pattern 500 is located in an outer area 212 of an area 211 corresponding to the maximum size of the document 1 in the transmissive read area 210 in the sub-scanning direction S when the upper cover 300 covers the platen cover 200.

An example of a main scanning distortion compensation process of a scanner as configured above is now described.

A read operation for main scanning distortion compensation may be initiated when a command to determine a main scanning scale compensation value is input from, for example, a host or an operation panel of the scanner. When the main scanning reference pattern 500 is integrally formed in the scanner, the read operation for main scanning distortion compensation may be performed whenever the document 1 is read, a certain quantity of the document 1 is read, the scanner is turned on, or the like.

The scan control unit 410 drives the image read unit 100 and reads the compensation chart 3 or the main scanning reference pattern 500 formed in the scanner. The electrical signal that is photoelectrically transformed by the linear image sensor 120 is converted by the A/D converter 420 to a digital value. The compensation value calculation unit 430 compares the read data with the main scanning reference pattern data that is previously stored in the memory 450, and calculates a plurality of main scanning scale compensation values respectively for the main scanning sections 510. For example, the length (read length) of each of the main scanning sections 510 may be calculated from the read data. The read length may be calculated by multiplying the number of pixels of the main scanning sections 510 by the resolution of the linear image sensor 120 in the main scanning direction M. When the calculated read length and a reference length of the main scanning reference pattern data are the same, no main scanning distortion is generated. When the read length and the reference length of the main scanning reference pattern data are different from each other, main scanning distortion is generated. A main scanning scale compensation value may be calculated from the calculated read length and the reference length of the main scanning reference pattern data. For example, when the read length is Lᵣ and the reference length is Lₘ, the main scanning scale compensation value is Lₘ/Lᵣ. The compensation value calculation unit 430 calculates a plurality of main scanning scale compensation values respectively for the main scanning sections 510. The calculated main scanning scale compensation values may be transmitted to the image processing unit 440 and stored in the memory 450.

The main scanning scale compensation values are applied to main scanning distortion compensation of an image read from the document 1. When an image is read from the document 1, the image processing unit 440 divides the read document image into a plurality of main scanning image areas respectively corresponding to the main scanning sections 510. The image processing unit 440 compensates the read document image by matching the main scanning scale compensation values respectively to the main scanning image areas, and creates compensated image data. The image processing unit 440 may output the compensated image data to the external device 2 or store the same in the memory 450.

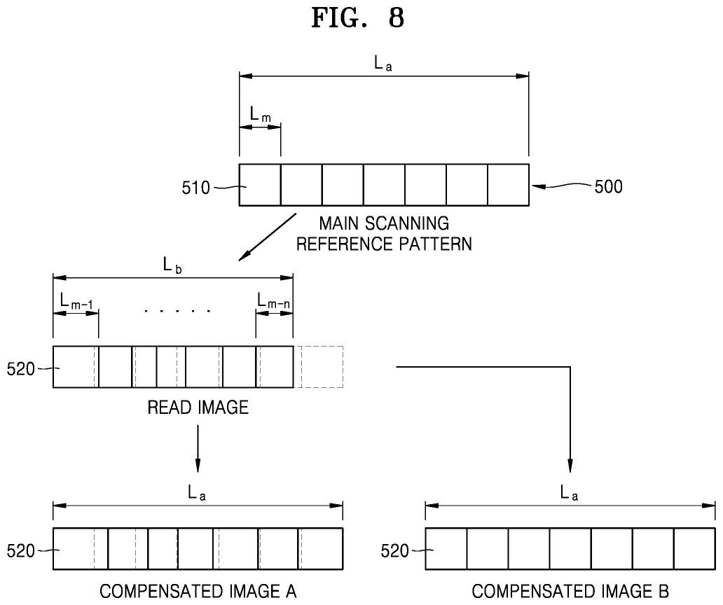

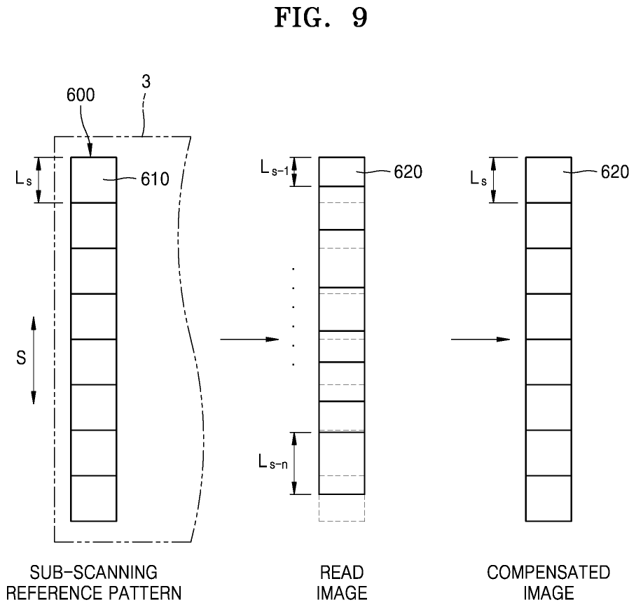

FIG. 8 illustrates a main scanning distortion compensation process, according to an example.

Referring to FIG. 8, the main scanning reference pattern 500 may include the main scanning sections 510, each having the reference length Lₘ. A total length of the main scanning reference pattern 500 is Lₐ. When the distortion of a lens is non-linear, the total length of a read image is L_{b}. A read length of each of a plurality of main scanning image areas 520 corresponding to the main scanning sections 510 ranges from Lₘ₋₁ to Lₘ₋ₙ. According to a related art compensation method, a main scanning scale compensation value Lₐ/L_{b} is applied to each of the main scanning image areas 520. Although a total length becomes Lₐ as in a compensated image A, the length of each of the main scanning image areas 520 is not Lₘ. Accordingly, the main scanning distortion due to the non-linearity of the distortion of a lens is not compensated in the method of the related art.

According to an example, a scale compensation value ranging from Lₘ/Lₘ-1 to Lₘ/Lₘ₋ₙ is applied to each of the main scanning image areas 520. Accordingly, as in a compensated image B, the length of each of the main scanning image areas 520 is Lₘ, and a total length becomes Lₐ. Accordingly, the main scanning distortion due to the non-linearity of the distortion of a lens may be compensated.

The main scanning distortion may be affected by chromatic aberration of the imaging optics 130. The compensation value calculation unit 430 may calculate a plurality of main scanning scale compensation values for the respective reference colors. For example, when the reference colors are R, G, and B, the scan control unit 410 may control the illumination unit 110 to sequentially emit lights of R, G, and B colors to the main scanning reference pattern 500. Alternatively, the scan control unit 410 may control the illumination unit 110 to emit a white light to the main scanning reference pattern 500. A reflected light is color-separated into lights of R, G, and B colors by the color filter of the linear image sensor 120, which are respectively incident on the R, G, and B pixels of the linear image sensor 120. Accordingly, R, G, and B image data may be obtained. The compensation value calculation unit 430 may compare each piece of R, G, and B image data with the main scanning reference pattern data, calculate the main scanning scale compensation values for the respective reference colors, and store the calculated main scanning scale compensation values, for example, in the memory 450. The image processing unit 440 may compensate for the distortion in the main scanning direction by applying the main scanning scale compensation values for the respective reference colors to the read image. According to the above configuration, the main scanning distortion due to a spherical error and chromatic aberration may be accurately compensated.

In the scanner, distortion in the sub-scanning direction S may be generated due to a factor such as mismatch between a moving speed of the image read unit 100 moving in the sub-scanning direction S and an exposure time for each unit line of the linear image sensor 120. This is due to the non-linearity of the driving unit for driving the image read unit 100. For example, a cyclic variation may be generated in the moving speed of the image read unit 100 due to eccentricity or roundness errors of a rotation member such as gears or pulleys forming the driving unit.

To compensate for the distortion in the sub-scanning direction S, the scanner according to an example reads a reference pattern and calculates from the reference pattern a scale compensation value in a plurality of areas in the sub-scanning direction S, and applies the scale compensation value to the image data read from the document 1, thereby performing the compensation.

FIG. 9 illustrates a sub-scanning reference pattern and a sub-scanning distortion compensation process, according to various examples.

Referring to FIG. 9, a sub-scanning reference pattern 600 may include a plurality of sub-scanning sections 610. The sub-scanning sections 610 are arranged in the sub-scanning direction S. The lengths Lₛ of the sub-scanning sections 610 may be the same or different from each other. In the present example, the lengths Lₛ of the sub-scanning sections 610 are the same. The number of the sub-scanning sections 610 is not particularly limited, and as the number thereof increases, the compensation of sub-scanning distortion may be performed more accurately. Information about the sub-scanning reference pattern 600, for example, the number and the length Lₛ of the sub-scanning sections 610 may be previously stored in the memory 450.

The sub-scanning reference pattern 600 may be implemented in various forms. For example, the sub-scanning reference pattern 600 may include a plurality of linear patterns that extend in the main scanning direction M or are obliquely inclined with respect to the sub-scanning direction S, and are arranged in the sub-scanning direction S. Each of the sub-scanning sections 610 is defined by two neighboring linear patterns of the plurality of linear patterns. The sub-scanning reference pattern 600 may include a plurality of solid patterns that are arranged spaced apart from each other in the sub-scanning direction S. Each of the sub-scanning sections 610 may be defined by each of the solid patterns and two neighboring solid patterns.

To compensate for distortion in the sub-scanning direction S, the scanner according to an example may include the compensation value calculation unit 430 that compares data read from the sub-scanning reference pattern 600 including the sub-scanning sections 610 arranged in the sub-scanning direction S with the previously stored data of the sub-scanning reference pattern 600 and calculates a plurality of sub-scanning scale compensation values respectively corresponding to the sub-scanning sections 610. The image processing unit 440 divides the image read from the document 1 into a plurality of main scanning image areas respectively corresponding to the sub-scanning sections 610, and applies a plurality of sub-scanning scale compensation values respectively to a plurality of sub-scanning image areas, thereby compensating for the distortion in the sub-scanning direction S.

The sub-scanning reference pattern 600 may be provided in the form of the compensation chart 3. In this case, to obtain a scale compensation value, the scanner reads the compensation chart 3 placed in the transmissive read area 210 of the platen cover 200.

The sub-scanning reference pattern 600 may be integrally formed in the scanner. According to an example as above, there is no need to prepare a separate compensation chart for distortion compensation. The sub-scanning reference pattern 600 may be located at a position of the platen cover 200 to be read by the image read unit 100. For example, as illustrated by a dashed line in FIG. 7, the sub-scanning reference pattern 600 may be located in an outer area 214 of an area 213 corresponding to the maximum size of the document 1 in the transmissive read area 210, in the main scanning direction M. The sub-scanning reference pattern 600 may be printed on the platen cover 200.

The sub-scanning reference pattern 600 may be located on the upper cover 300 to be read by the image read unit 100. For example, as illustrated in FIG. 7, the white sheet 310 is provided on an inner surface of the upper cover 300 facing the platen cover 200. The sub-scanning reference pattern 600 may be formed on the white sheet 310. In this case, the sub-scanning reference pattern 600 may be formed on the white sheet 310 such that the sub-scanning reference pattern 600 is located in an outer area 214 of an area 213 corresponding to the maximum size of the document 1 in the transmissive read area 210 in the main scanning direction M when the upper cover 300 covers the platen cover 200.

An example of a sub-scanning distortion compensation process configured as above is described.

A read operation for sub-scanning distortion compensation may be initiated when a command to determine a sub-scanning scale compensation value is input from, for example, a host or an operation panel of the scanner. When the sub-scanning reference pattern 600 is integrally formed in the scanner, the read operation for sub-scanning distortion compensation may be performed whenever the document 1 is read, a certain quantity of the document 1 is read, the scanner is turned on, or the like.

The scan control unit 410 drives the image read unit 100 and reads the compensation chart 3 or the sub-scanning reference pattern 600 formed in the scanner. The electrical signal that is photoelectrically transformed by the linear image sensor 120 is converted by the A/D converter 420 to a digital value. The compensation value calculation unit 430 compares the read data with the sub-scanning reference pattern data that is previously stored in the memory 450, and calculates a plurality of sub-scanning scale compensation values respectively for the sub-scanning sections 610. For example, the length (read length) of each of the sub-scanning sections 610 may be calculated from the read data. The read length may be calculated by multiplying the number of pixels of the sub-scanning sections 610 by the resolution of the linear image sensor 120 in the sub-scanning direction S. When the calculated read length and a reference length of the sub-scanning reference pattern data are the same, no sub-scanning distortion is generated. When the read length and the reference length of the sub-scanning reference pattern data are different from each other, sub-scanning distortion is generated. A sub-scanning scale compensation value may be calculated from the calculated read length and the reference length of the sub-scanning reference pattern data. When the read length of each of a plurality of main scanning image areas 620 respectively corresponding to the sub-scanning sections 610 ranges from L_{S-1} to L_{S-n}, the sub-scanning scale compensation value for each of the main scanning image areas 620 ranges from L_{S}/L_{S-1} to L_{S}/L_{S-n}. The calculated sub-scanning scale compensation values may be transmitted to the image processing unit 440 and then stored in the memory 450.

The sub-scanning scale compensation values are applied to the sub-scanning distortion compensation of the image read from the document 1. When an image is read from the document 1, the image processing unit 440 divides the read document image into a plurality of sub-scanning image areas respectively corresponding to the sub-scanning sections 610. The image processing unit 440 compensates the read document image by matching the sub-scanning scale compensation values respectively to the sub-scanning image areas, and creates compensated image data. The image processing unit 440 may output the compensated image data to the external device 2 or store the same in the memory 450. According to the above configuration, distortion in the sub-scanning direction S may be compensated.

Although in the above-described examples the main scanning distortion and the sub-scanning distortion are described to be respectively compensated, the main scanning scale compensation value and the sub-scanning scale compensation value may be simultaneously calculated and applied, and thus the main scanning distortion and the sub-scanning distortion of the read image may be simultaneously compensated.

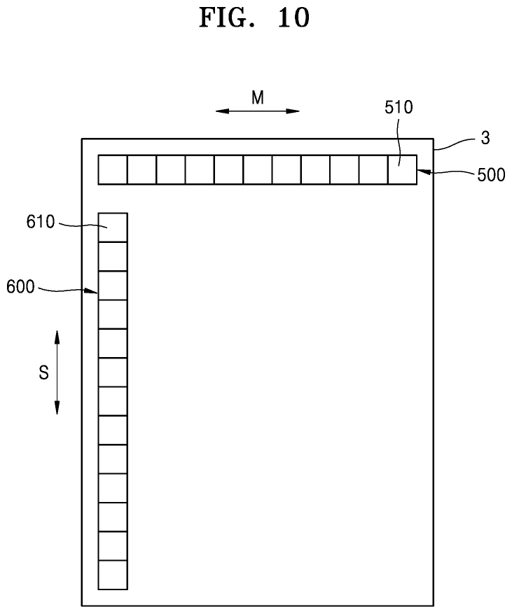

FIG. 10 illustrates a compensation chart, according to an example.

Referring to FIG. 10, the compensation chart 3 may include, for example, the main scanning reference pattern 500 in which the main scanning sections 510 are arranged in the main scanning direction M and the sub-scanning reference pattern 600 in which the sub-scanning sections 610 are arranged in the sub-scanning direction S.

While one or more examples have been described with reference to the figures, it will be understood by those of ordinary skill in the art that various changes in form and details may be made therein without departing from the spirit and scope as defined by the following claims.

Also, any method as described above may be implemented in a form of a computer-readable storage medium storing data or instructions executable by a computer or a processor. The method may be written as computer programs and may be implemented in general-use digital computers that execute the programs using a computer-readable storage medium. Examples of the computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disk (SSD), and any devices that may store instructions or software, related data, data files, and data structures and may provide instructions or software, related data, data files, and data structures to a processor or a computer to allow the processor or the computer to execute instructions.

What is claimed is:

1. A scanner comprising:
an image read unit including an illumination unit to emit light onto a document, a linear image sensor having a length in a main scanning direction, and imaging optics to image light reflected from the document on the linear image sensor, wherein at least one of the illumination unit, the imaging optics, or the linear image sensor is movable in a sub-scanning direction;
a compensation value calculation unit to:
compare data read from a main scanning reference pattern including a plurality of main scanning sections arranged in the main scanning direction with data of the main scanning reference pattern that is previously stored, and
calculate a plurality of main scanning scale compensation values respectively corresponding to the plurality of main scanning sections; and
an image processing unit to compensate for distortion in the main scanning direction by dividing an image read from the document into a plurality of main scanning image areas respectively corresponding to the plurality of main scanning sections and applying the plurality of main scanning scale compensation values respectively to the plurality of main scanning image areas.

2. The scanner of claim 1, further comprising a platen cover including a transmissive read area in which the document is placed and a home position area located at a side of the transmissive read area in the sub-scanning direction, the platen cover being located above the image read unit,
wherein the main scanning reference pattern is located on a lower portion of the platen cover corresponding to the home position area.

3. The scanner of claim 2, wherein a shading sheet is provided on the lower portion of the platen cover corresponding to the home position area, and the main scanning reference pattern is formed on the shading sheet.

4. The scanner of claim 1, further comprising:
a platen cover including a transmissive read area in which the document is placed and a home position area located at a side of the transmissive read area in the sub-scanning direction, the platen cover being located above the image read unit; and
an upper cover that is openable and closable for covering the platen cover,
wherein the main scanning reference pattern is located on a lower portion of the upper cover.

5. The scanner of claim 1,
wherein the compensation value calculation unit calculates the plurality of main scanning scale compensation values for respective reference colors, and
wherein the image processing unit compensates for the distortion in the main scanning direction by applying the plurality of main scanning scale compensation values respectively to the plurality of main scanning image areas for the respective reference colors.

6. The scanner of claim 1, wherein lengths of the plurality of main scanning sections in the main scanning direction are the same.

7. The scanner of claim 1, wherein the main scanning reference pattern comprises a plurality of linear patterns arranged in the main scanning direction.

8. The scanner of claim 1, wherein the main scanning reference pattern comprises a plurality of solid patterns arranged in the main scanning direction.

9. The scanner of claim 1,
wherein the compensation value calculation unit compares data read from a sub-scanning reference pattern including a plurality of sub-scanning sections arranged in the sub-scanning direction with data of the sub-scanning reference pattern that is previously stored, and calculates a plurality of sub-scanning scale compensation values respectively corresponding to the plurality of sub-scanning sections, and
wherein the image processing unit compensates for distortion in the sub-scanning direction by dividing an image read from the document into a plurality of sub-scanning image areas respectively corresponding to the plurality of sub-scanning sections, and applying the plurality of sub-scanning scale compensation values respectively to the plurality of sub-scanning image areas.

10. The scanner of claim 9, further comprising:
a platen cover including a transmissive read area in which the document is placed and a home position area located at a side of the transmissive read area in the sub-scanning direction, the platen cover being located above the image read unit; and
an upper cover that is openable and closable for covering the platen cover,
wherein the sub-scanning reference pattern is located on at least one of a lower portion of the platen cover or the upper cover to be readable by the image read unit.

11. A scanner comprising:
an image read unit including an illumination unit to emit light onto a document, a linear image sensor having a length in a main scanning direction, and imaging optics to image light reflected from the document on the linear image sensor, wherein at least one of the illumination unit, the imaging optics, or the linear image sensor is movable in a sub-scanning direction;
a platen cover including a transmissive read area in which the document is placed and a home position area located at a side of the transmissive read area in the sub-scanning direction, the platen cover being located above the image read unit;
an upper cover that is openable and closable for covering the platen cover; and
a main scanning reference pattern located on at least one of a lower portion of the platen cover or the upper cover to be readable by the image read unit, and including a plurality of main scanning sections arranged in the main scanning direction.

12. The scanner of claim 11, wherein the main scanning reference pattern is located on the lower portion of the platen cover corresponding to the home position area.

13. The scanner of claim 12,
wherein a shading sheet is provided on the lower portion of the platen cover corresponding to the home position area, and
wherein the main scanning reference pattern is formed on the shading sheet.

14. The scanner of claim 11, wherein the main scanning reference pattern is located on the upper cover.

15. The scanner of claim 11, further comprising a sub-scanning reference pattern that is located on at least one of the lower portion of the platen cover and the upper cover to be readable by the image read unit and includes a plurality of sub-scanning sections arranged in the sub-scanning direction.
